(19) United States
(12) Patent Application Publication
(10) Pub. No.: US 2009/0218899 A1
(43) Pub. Date: Sep. 3, 2009

(54) A MOTION TRANSFER SYSTEM

(75) Inventor: Joseph Carey, Norfolk (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: C. J. RESEARCH LTD., Dunleer, Co. Louth (IE)

(21) Appl. No.: 12/090,780

(22) PCT Filed: Oct. 19, 2006
(86) PCT No.: PCT/GB2006/003892

§ 371 Date: Aug. 7, 2008

(30) Foreign Application Priority Data
Oct. 19, 2005 (GB) 05 21191.7
Nov. 16, 2005 (GB) 05 23315.0

(51) Int. Cl. H02K 21/12; H02K 53/00

(52) U.S. Cl. 310/152; 415/916

(57) ABSTRACT

A motion transfer system comprising stator magnets (24-27) and rotor magnets (22-23) adapted to be displaced relative to each other on a linear or rotating path. The stator magnets (24-27) are reciprocally movable on a direction inclined to the direction of relative movement between stator and rotor magnets. Auxiliary magnets (29), fixed to the stator, are arranged such that the magnetic force between stator magnets (24-27) and rotor magnets (22-23) at least partially cancels the magnetic force between stator magnets (24-27) and rotor magnets (22-23) when the rotor magnets (22-23) are at least partially between stator magnets (24-27) and auxiliary magnets (29).

The present invention relates to a motion transfer system. More particularly, but not exclusively, the present invention relates to a motion transfer system whereby motion of secondary magnetic means along a motion path produces motion of a primary first magnetic means, the system comprising a further magnet arranged such that the second magnetic means comes under the magnetic influence of the further magnet before it leaves the magnetic influence of the primary first magnetic means.

Motion transfer systems involving magnets are known. U.S. Pat. No. 3,992,132 describes a transfer system whereby magnets are arranged to cancel the magnetic force on the rotor arm during use. Such an arrangement however does not equalise the forces on the rotor aim along the direction of travel. This increases wear on the motion transfer system reducing reliability.

The present invention seeks to overcome this problem.

Accordingly the present invention provides a motion transfer system comprising;
at least one magnet set comprising primary and secondary first magnetic means spaced apart along a motion path, the primary first magnetic means being adapted to be displaced along a path inclined to the motion path and a secondary first magnetic means being disposed at a fixed distance from said motion path;
second magnetic means being disposed at a fixed distance from said motion path;
the first and second magnetic means being adapted to be displaced relative to each other in a direction substantially parallel to said motion path such that the second magnetic means passes proximate to the primary and secondary first magnetic means;
the first primary magnetic means being adapted to be displaced along said inclined path by the second magnetic means as the second magnetic means passes proximate thereto;
the first and second magnetic means being arranged such that the magnetic force between secondary first magnetic means and second magnetic means at least partially cancels the magnetic force between primary first magnetic means and second magnetic means when the second magnetic means is located at least partially between the primary and secondary first magnetic means.

Preferably, the magnet set remains fixed and the second magnetic means is displaced parallel to the motion path.

Alternatively, the second magnetic means remains fixed and the magnet set is displaced parallel to the motion path.

Preferably, the motion path is a line having first and second ends, at least one of the magnet set and second magnetic means being adapted to be displaced reciprocally between the first and second ends.

Alternatively, the motion path is an endless loop, preferably circular.

Preferably, the second magnetic means is attached to a rotor and rotates relative to the magnet set.

The motion transfer system can comprise a plurality of spaced apart second magnetic means

The magnet set can further comprises a tertiary first magnetic means arranged between primary and secondary first magnetic means.

Preferably, the tertiary magnetic means is arranged closer to the primary first magnetic means than the secondary first magnetic means, preferably less than 40% of the distance between the primary and secondary first magnetic means, more preferably less than 25% of the distance between the primary and secondary first magnetic means, more preferably less than 10% of the distance between the primary and secondary first magnetic means.

The motion transfer system can further comprise a plurality of first magnet sets arranged along the motion path.

The primary first magnetic means of one magnet set can be arranged proximate to the secondary first magnetic means of the adjacent magnet set.

Preferably, the distance between the primary first magnetic means of one magnet set and the secondary first magnetic means of an adjacent magnet set is less than 40% of the distance between the primary first magnetic means of the one magnet set and the primary first magnetic means of the adjacent magnet set.

Preferably, the length of the second magnetic means along the motion path is substantially equal to the distance between the primary and secondary first magnetic means.

Alternatively, the length of the second magnetic means along the motion path is less than the distance between the primary and secondary first magnetic means.

Alternatively, the length of the second magnetic means along the motion path is greater than the distance between the primary and secondary first magnetic means.

The present invention will now be described by way of example only and not in any limitative sense with the reference to the accompany drawings in which

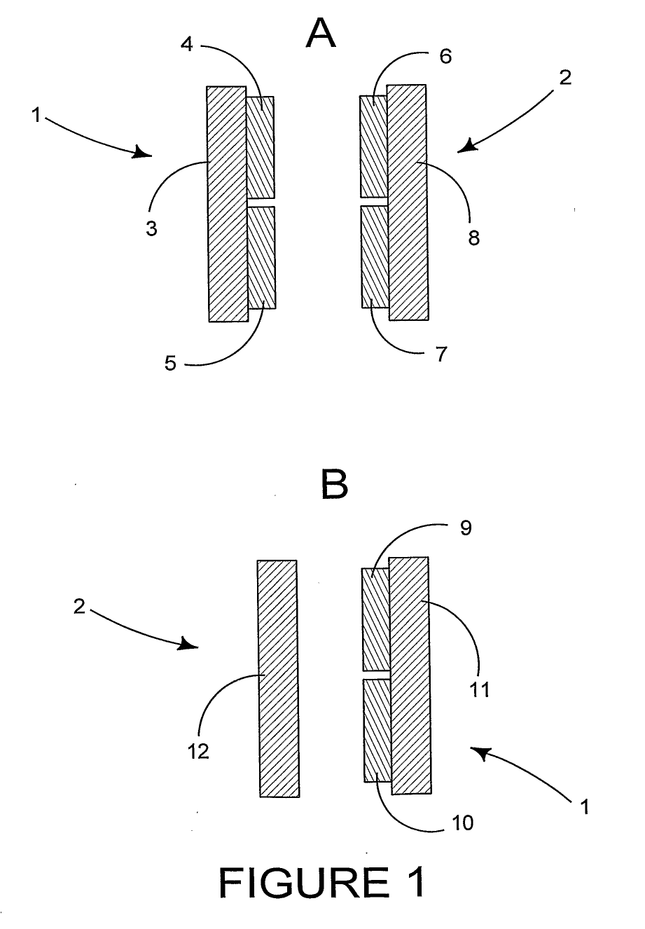

FIG. 1 shows a primary first magnetic means and second magnetic means according the invention;

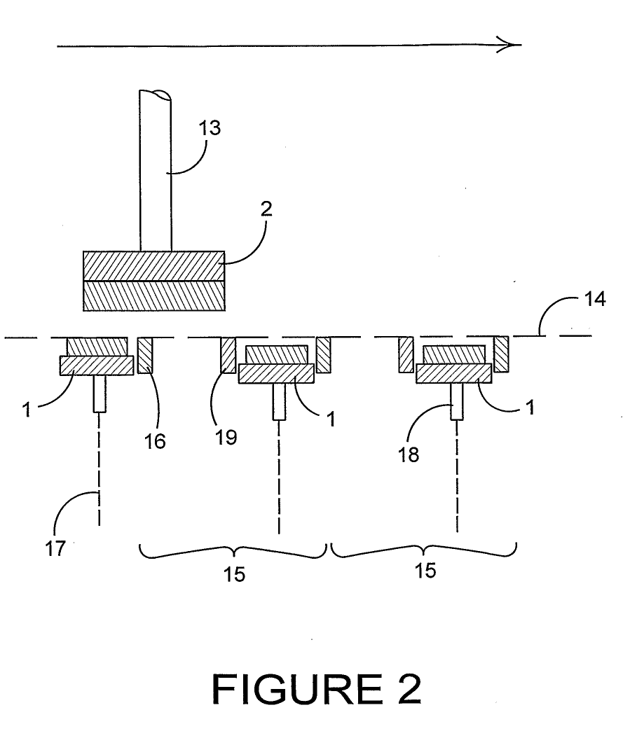

FIG. 2 shows a first embodiment of a motion transfer system according to the invention; and

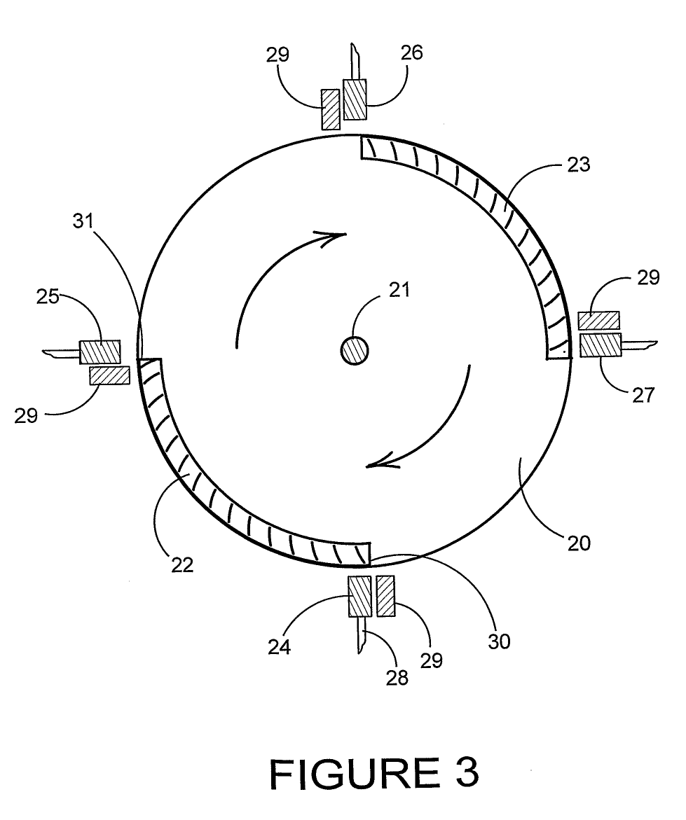

FIG. 3 shows a second embodiment for a motion transfer system according to the invention.

With reference to FIG. 1. ‘A’ shows a possible layout relationship between a primary first magnetic means 1 and a second magnetic means 2 according to the invention. Both magnetic means 1,2 are made up of permanent magnets. It is shown in ‘A’ a ferromagnetic base 3 with two permanent magnets 4,5 attached with opposite poles facing outwards forming a ‘horseshoe’ magnetic effect and working in conjunction with magnets 6,7 also fixed to a ferromagnetic base 8. Subject to the air gap distance (inverse square law) between the above assemblies and the power of the magnets a considerable attraction force will result from the above relationship. With reference to ‘B’ of FIG. 1 only one of the first and second magnetic means 1,2 has permanent magnets 9,10 mounted on ferromagnetic base 11 and working in conjunction with ferromagnetic material 12. A force of attraction likewise will be experienced between these two bodies. Either one can form the primary first magnetic means 1 or the second magnetic means 2.

Shown in FIG. 2 in end view is a motion transfer system according to the invention. A support arm 13 carries second magnetic means 2. The support arm 13 has a reciprocating action along a motion path 14. On the opposite side of the motion path 14 are a plurality of magnet sets 15. Each magnet set 15 comprises a primary and secondary first magnetic means 1, 16 spaced apart along the motion path 14. Each primary first magnetic means 1 is adapted to be displaced along a path 17 orthogonal to the motion path 14. Each secondary first magnetic means 16 is a fixed distance from the motion path 14. Each of the primary first magnetic means 1 has attached to it a power output rod 18. A fixed tertiary first magnetic means 19, is arranged proximate to the primary first magnetic means 1 in each magnet set 15.

The primary first magnetic means 1 is activated due to the attraction force of second magnetic means 2 whilst the remaining primary first magnetic means 1 have not been activated with reference to the motion path 14. It can be seen that second magnetic means 2 is partially covering the face of the primary first magnetic means 1 and the leading edge of the second magnetic means 2 (moving to the right) is in close proximity to a fixed tertiary magnetic means 19 resulting in an attractive pulling force between both, which assists the second magnet means 2 via its drive means to move to the right. Once second magnetic means 2 has cleared the primary first magnetic means 1 the primary first magnetic means 1 will return to its deactivated position with reference to motion path 14 and the primary magnetic means 1 in the next magnet set 15 will be activated. This action is repeated as the second magnetic means 2 moves right and left during its reciprocating action.

With reference to FIG. 3 a rotary version of this invention is described and shown. Disk 20 is the main primary assembly base which is driven via centre shaft 21. For ease of explanation only two second magnetic means 22 and 23 are shown with four primary first magnetic means 24-27 supported by their power output rods 28 and fixed secondary first magnetic means 29. The second magnetic means 22, 23 all have the same polarity in the given path and the primary and secondary first magnetic means 24-27, 29 all have the opposite polarity in the given path. The ideal magnetic assemblies for both first and second magnetic means 22-27, 29 would be that each means consist of pairs of magnets (two poles) horseshoe design. The available output power will be dictated by the power of the magnets, their stroke length and the number of magnetic assemblies in the system.

The second magnetic means 22, 23 move successively into alignment with the first primary magnetic means 24-27, thereby producing transverse movement of the first primary magnetic means 24-27 by a force of attraction. The motion and physical dimensions of the second magnetic means 22, 23 must be as such to provide sufficient time for the first primary magnetic means 24-27 to move through their working stroke. Power-output means are operated by this transverse movement of the first primary magnetic means 24-27. One would expect the second magnetic means 22, 23 to experience a pull back, ‘magnetic hold’ by the last activated first primary magnetic means 24-27, but this angular pulling force which is substantially parallel to the path of motion is substantially cancelled out by the attraction force in the forward direction by the next secondary first magnetic means 29 acting as a ‘bait’ to the leading edge of the advancing second magnetic means 22, 23 in its path of motion. The equalization of the above angular force as practiced by this invention results in minimum energy requirement to produce the said motion of the second magnetic means 22, 23. It can be seen that first primary magnetic means 24, 27 are activated, that is they are subject to the attraction forces between themselves and second magnetic means 22, 23. It will be obvious that as disk 20 is rotated, as indicated by arrows, the trailing edge 30 of the second magnetic means 22 is partially covering the face area of primary first magnetic means 24 whilst lead edge 31 is experiencing a pulling force from secondary first magnetic means 29 due to its close proximity. This pulling force and its assistance in the motion of the second magnetic means 22 results in an almost equalization of the forces pulling back second magnetic means 22 by primary first magnetic means 24 and the pulling forward by the secondary first magnetic means 29. The somewhat balancing of these forces reduces the input power required by the primary drive system. It can be deduced from FIG. 3 that due to the direction of motion of the second magnetic means 22, 23 that second magnetic means 23 has just moved away from primary first magnetic means 26 which is now deactivated and primary first magnetic means 27 has just been activated. The fixed secondary first magnetic means 29 can be permanent magnets and/or ferromagnetic material and the dimensions of same will be dictated by the attraction force required for any given system.

As already described above the power output from this motion transfer system according to the invention is derived solely from the transverse displacement of the primary first magnetic means which is connected to an output means of choice. The said displacement of the primary first magnetic means results directly from the attractive pulling force on the second magnetic means by the second magnetic means or ferromagnetic material working in conjunction with the primary first magnetic means. The primary first magnetic means is returned to its resting position by a spring, gravity or any convenient means. The power output is derived by pulling the primary first magnetic means forward with its attached output power means as practiced in this invention, however, this energy can be stored in a spring or other means and released in a controlled manner on demand.

1-15. (canceled)

16. A motion transfer system comprising:
at least one magnet set comprising primary and secondary first magnetic means spaced apart along a motion path, the primary first magnetic means being adapted to be displaced along a path inclined to the motion path and a secondary first magnetic means being disposed at a fixed distance from said motion path;
second magnetic means being disposed at a fixed distance from said motion path;
the first and second magnetic means being adapted to be displaced relative to each other in a direction substantially parallel to said motion path such that the second magnetic means passes proximate to the primary and secondary first magnetic means;
the primary first magnetic means being adapted to be displaced along said inclined path by the second magnetic means as the second magnetic means passes proximate thereto;
the first and second magnetic means being arranged such that the magnetic force between secondary first magnetic means and second magnetic means at least partially cancels the magnetic force between primary first magnetic means and second magnetic means when the second magnetic means is located at least partially between the primary and secondary first magnetic means.

17. A motion transfer system as claimed in claim 16, wherein the magnet set remains fixed and the second magnetic means is displaced parallel to the motion path.

18. A motion transfer system as claimed in claim 16, wherein the second magnetic means remains fixed and the magnet set is displaced parallel to the motion path.

19. A motion transfer system as claimed in claim 16, wherein the motion path is a line having first and second ends, at least one of the magnet set and second magnetic means being adapted to be displaced reciprocally between the first and second ends.

20. A motion transfer system as claimed in claim 16, wherein the motion path is an endless loop.

21. A motion transfer system as claimed in claim 16, wherein the motion path is an endless circular loop.

22. A motion transfer system as claimed in claim 20, wherein the second magnetic means is attached to a rotor and rotates relative to the magnet set.

23. A motion transfer system as claimed in claim 16 comprising a plurality of spaced apart second magnetic means.

24. A motion transfer system as claimed in claim 16 wherein the magnet set further comprises a tertiary first magnetic means arranged between primary and secondary first magnetic means.

25. A motion transfer system as claimed in claim 16 wherein the tertiary magnetic means is arranged closer to the primary first magnetic means than to the secondary first magnetic means to form a first distance, said first distance being less than 10% of the distance between the primary and secondary first magnetic means.

26. A motion transfer system as claimed in claim 16 wherein the tertiary magnetic means is arranged closer to the primary first magnetic means than to the secondary first magnetic means to form a first distance, said first distance being less than 25% of the distance between the primary and secondary first magnetic means.

27. A motion transfer system as claimed in claim 16 wherein the tertiary magnetic means is arranged closer to the primary first magnetic means than to the secondary first magnetic means to form a first distance, said first distance being less than 40% of the distance between the primary and secondary first magnetic means.

28. A motion transfer system as claim in claim 16 further comprising a plurality of first magnet sets arranged along the motion path.

29. A motion transfer system as claimed in claim 28, wherein the primary first magnetic means of one magnet set is arranged proximate to the secondary first magnetic means of the adjacent magnet set.

30. A motion transfer system as claimed in claim 29, wherein the distance between the primary first magnetic means of one magnet set and the secondary first magnetic means of an adjacent magnet set is less than 40% of the distance between the primary first magnetic means of the one magnet set and the primary first magnetic means of the adjacent magnet set.

31. A motion transfer system as claimed in claim 28 wherein the length of the second magnetic means along the motion path is substantially equal to the distance between the primary and secondary first magnetic means of a magnet set.

32. A motion transfer system as claimed in claim 28 wherein the length of the second magnetic means along the motion path is less than the distance between the primary and secondary first magnetic means of a magnet set.

33. A motion transfer system as claimed in claim 28 wherein the length of the second magnetic means along the motion path is greater than the distance between the primary and secondary first magnetic means of a magnet set.
